(19) United States
(12) Patent Application Publication
(10) Pub. No.: US 2017/0195067 A1
(43) Pub. Date: Jul. 6, 2017

(54) METHOD AND ELECTRONIC DEVICE FOR MEASURING BATTERY CAPACITY OF MOBILE COMMUNICATION TERMINAL EQUIPMENT

(71) Applicants: Le Holdings (Beijing) Co., Ltd., Beijing (CN); Lemobile Information Technology (Beijing) Co., Ltd, Beijing (CN)

(72) Inventor: Zhongqian Zhou, Beijing (CN)

(73) Assignees: Le Holdings (Beijing) Co., Ltd., Beijing (CN); Lemobile Information Technology (Beijing) Co., Ltd ., Beijing (CN)

(21) Appl. No.: 15/243,354

(22) Filed: Aug. 22, 2016

Related U.S. Application Data
(63) Continuation of application No. PCT/CN2016/088318, filed on Jul. 4, 2016.

(30) Foreign Application Priority Data
Dec. 30, 2015 (CN) 201511023851.9

(51) Int. Cl. H04B 17/10; H04W 72/04

(52) U.S. Cl. CPC H04B 17/103; H04W 72/048

(57) ABSTRACT

The application discloses a method and electronic device for measuring quantity of electric charge of battery of mobile communication terminal equipment. The method includes: acquiring an operating state and related parameters of a radio frequency module; determining a measuring time of a battery voltage according to the operating state and the related parameters; measuring the battery voltage to obtain a basic voltage value at the measuring time; compensating the basic voltage value to obtain a compensated voltage value according to the operating state and the related parameters; and obtaining the quantity of electric charge of battery according to the compensated voltage value.

### CROSS REFERENCE TO RELATED APPLICATIONS

This application is a continuation of International Application No. PCT/CN2016/088318, filed on Jul. 4, 2016, which is based upon and claims priority to Chinese Patent Application No. 201511023851.9, field on Dec. 30, 2015, and the entire contents of which are incorporated herein by reference.

### TECHNICAL FIELD

This application relates to the field of electronic measurement technologies, and specifically to a method and electronic device for measuring quantity of electric charge of battery of mobile communication terminal equipment.

### BACKGROUND

In the prior art, there are mainly two types of methods for measuring the quantity of electric charge of battery, namely a voltage measurement method and a coulometer method. The coulometer method has high precision but needs a special circuit for implementation, and thus is complex, and is high in cost. At present, the most popular, simplest, most convenient and fastest method for measuring the quantity of electric charge of battery is the voltage measurement method: the quantity of electric charge of battery is derived by measuring the voltage between two poles of a battery and using a relation curve between the quantity of electric charge of battery and the battery voltage. Therefore, the accuracy of the battery voltage is very important for correctly estimating the battery remaining capacity.

The relation curve between the quantity of electric charge of battery and the battery voltage given by a battery manufacturer is actually the relation curve between the quantity of electric charge of battery and a battery open circuit voltage, i.e., an ideal curve obtained in the case without any battery load. The battery voltage measured in practical application is greatly influenced by the battery load, and most quantity of electric charge of battery measuring technologies based on voltage at present generally make various compensation treatments on the basis of the measured battery voltage to eliminate battery voltage instability so as to improve the accuracy in the measurement of quantity of electric charge of battery. For example, the Chinese patent application CN201310594575.6 discloses a method for measuring quantity of electric charge of battery, which calculates the compensation voltage of each power consuming device after considering the influences of power consuming devices including an LCD backlight, a CPU, a GPU and the like on the battery voltage, is, and obtains the quantity of electric charge of battery according to the compensated voltage. However, such type of the conventional compensation technologies can only meet the measurement requirements of the quantity of electric charge of battery of common terminal equipment, and for the mobile communication terminal equipment, it still fails to obtain an accurate quantity of electric charge of battery measurement result, so that it is likely to result in failure to use the equipment normally, and it may also result in a too long charging time or insufficient charging in a recharging process.

### SUMMARY

This application discloses a method and electronic device for measuring quantity of electric charge of battery of mobile communication terminal equipment, by which the quantity of electric charge of battery of the mobile communication terminal equipment can be accurately measured.

One objective of the embodiments of this application is to provide a method for measuring quantity of electric charge of battery of mobile communication terminal equipment, including acquiring an operating state and related parameters of a radio frequency module; determining a measuring time of a battery voltage according to the operating state and the related parameters; measuring the battery voltage to obtain a basic voltage value at the measuring time; compensating the basic voltage value to obtain a compensated voltage value according to the operating state and the related parameters; and obtaining the quantity of electric charge of battery according to the compensated voltage value.

Another objective of the embodiments of this application is to provide an electronic device for measuring quantity of electric charge of battery of mobile communication terminal equipment, including at least one processor; and a memory in communication connection with the at least one processor, where the memory stores instructions that can be executed by the at least one processor, and the instructions are executed by the at least one processor to enable the at least one processor to: acquire an operating state and related parameters of a radio frequency module; determine a measuring time of a battery voltage according to the operating state and the related parameters; measure the battery voltage to obtain a basic voltage value at the measuring time; compensate the basic voltage value to obtain a compensated voltage value according to the operating state and the related parameters; and obtain the quantity of electric charge of battery according to the compensated voltage value.

Another objective of the embodiments of this application is to provide a non-volatile computer storage medium, and the non-volatile computer storage medium stores computer executable instructions that are used for: acquiring an operating state and related parameters of a radio frequency module; determining a measuring time of a battery voltage according to the operating state and the related parameters; measuring the battery voltage to obtain a basic voltage value at the measuring time; compensating the basic voltage value to obtain a compensated voltage value according to the operating state and the related parameters; and obtaining the quantity of electric charge of battery according to the compensated voltage value.

The method and the electronic device for measuring the quantity of electric charge of battery of the mobile communication terminal equipment, provided by embodiments of this application, determines a measuring time of the battery voltage according to the operating state and the related parameters of the radio frequency module, obtains a basic voltage value by measuring at the measuring time, and obtains a compensated voltage value according to the operating state and the related parameters of the radio frequency module to compensate the influence of the radio frequency module on the fluctuation of the battery voltage, so as to accurately obtain the quantity of electric charge of battery of the mobile communication terminal equipment.

### BRIEF DESCRIPTION OF THE DRAWINGS

One or more embodiments are illustrated by way of example, and not by limitation, in the figures of the accompanying drawings, where elements having the same reference numeral designations represent like elements throughout. The drawings are not to scale, unless otherwise disclosed.

FIG. 1 shows a flow diagram of the method for measuring the quantity of electric charge of battery of mobile communication terminal equipment according to an embodiment of this application;

FIG. 2 shows a flow diagram of a preferred embodiment of the method for measuring the quantity of electric charge of battery of mobile communication terminal equipment according to an embodiment of this application;

FIG. 3 shows a schematic diagram of the system for measuring the quantity of electric charge of battery of mobile communication terminal equipment according to an embodiment of this application; and

FIG. 4 shows a schematic diagram of a hardware structure of the electronic device for executing the method for measuring the quantity of electric charge of battery of mobile communication terminal equipment according to an embodiment of this application.

### DETAILED DESCRIPTION

To make the objectives, the technical solution and the advantages of the embodiments of this application clearer, the technical solution of this application will be clearly and completely described hereinafter through implementation with reference to the accompanying drawings in the embodiments of this application. Apparently, the embodiments described below are a part, instead of all, of the embodiments of this application.

Compared with conventional terminal equipment, the mobile communication terminal equipment has a significant characteristic of having a radio frequency module which is a high-current power-consuming module and the start or stop of which will cause great fluctuation of battery voltage and influence the accuracy of electric quantity measurement, so that the battery voltage measured by a voltage measuring module in the mobile communication terminal equipment needs compensation to ensure the accuracy of estimating the quantity of electric charge of battery according to a relation curve between the quantity of electric charge of battery and the battery voltage. In this application, the mobile communication terminal equipment includes, but is not limited to, a cell phone, an interphone, a tablet computer, a notebook computer, and the like.

### Embodiment 1

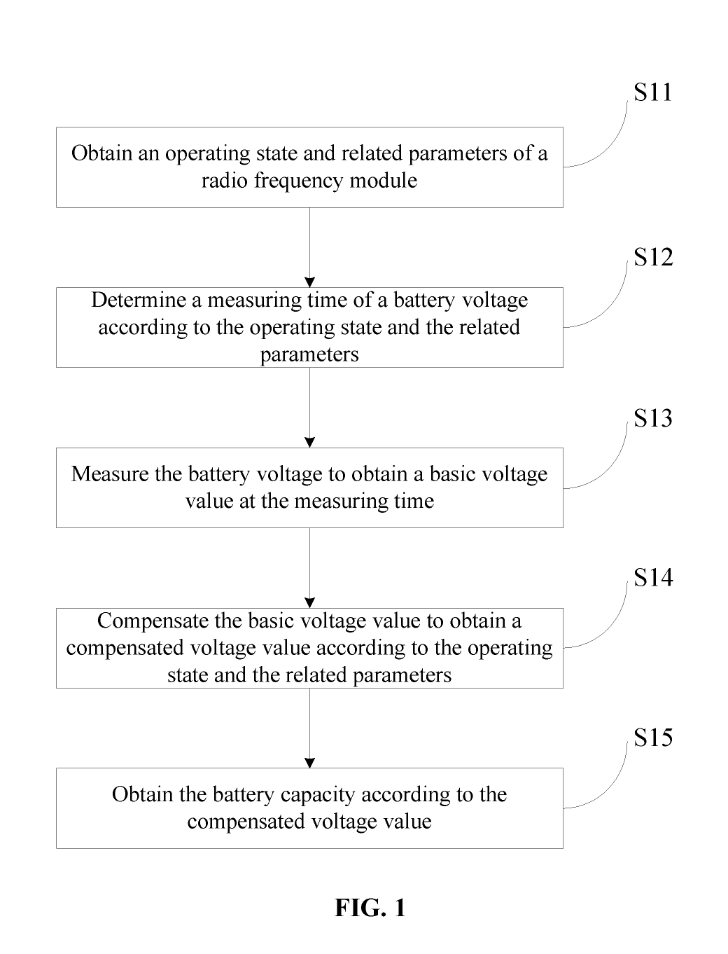

In order to accurately measure the quantity of electric charge of battery of mobile communication terminal equipment, the embodiment of this application provides a method for measuring the quantity of electric charge of battery of mobile communication terminal equipment, and as shown in FIG. 1, the method includes the following steps:

S11: acquiring an operating state and related parameters of a radio frequency module. The operating state and the related parameters of the radio frequency module can be obtained through a micro-processor of the mobile communication terminal equipment. Generally, the radio frequency module may be a radio frequency transceiver consisting of a relatively independent receiving unit and a relatively independent transmitting unit. For a radio frequency transceiver, the operating state to be obtained includes an operating state S_{TX} of the transmitting unit of the radio frequency transceiver, namely in an activated state or an idle state, and an operating state S_{RX} of the receiving unit, namely in an activated state or an idle state; and the related parameters to be obtained include a transmitting start time t_{TX}, a transmitting duration D_{TX} and a transmitting power P_{TX} of the transmitting unit in each transmitting time slot, and a receiving start time t_{RX}, a receiving duration D_{RX} and a receive gain G_{RX} of the receiving unit in each receiving time slot. Certainly, for some mobile communication terminal equipment, the radio frequency module may only have a transmitting unit or a receiving unit, and in this case, only the operating state and the related parameters of the transmitting unit or the receiving unit are obtained.

S12: determining a measuring time t_{VM} of a battery voltage according to the operating state and the related parameters of the radio frequency module. In order to compensate for the influence of the radio frequency module on the fluctuation of the battery voltage, the battery voltage needs to be measured when the radio frequency module is in operating state. In order to make the measurement result more accurate, as a preferred implementation scheme, the measuring time t_{VM} is selected to be the midpoint of the operating time period of the radio frequency module, and at this time, the influence of the radio frequency module on the fluctuation of the battery voltage is most stable. Certainly, the measuring time selected to be earlier or later is feasible as long as it is within the operating time period of the radio frequency module.

S13: measuring the battery voltage at the measuring time t_{VM} to obtain a basic voltage value V₀.

S14: compensating the basic voltage value V₀ according to the operating state and the related parameters of the radio frequency module to obtain a compensated voltage value V_{C}.

S15: obtaining the quantity of electric charge of battery according to the compensated voltage value. This step is the same as a conventional voltage measurement method, namely the quantity of electric charge of battery Q_{C}=f(V_{C}) is calculated according to the obtained voltage value and the relation curve Q=f(V) between the quantity of electric charge of battery and the battery voltage.

According to a method for measuring the quantity of electric charge of battery of the mobile communication terminal equipment, provided by the embodiments of this application, a measuring time of the battery voltage is determined according to the operating state and the related parameters of the radio frequency module, a basic voltage value is obtained by measuring at the measuring time, and a compensated voltage value is obtained according to the operating state and the related parameters of the radio frequency module to compensate the influence of the radio frequency module on the fluctuation of the battery voltage, so that the quantity of electric charge of battery of the mobile communication terminal equipment can be accurately obtained.

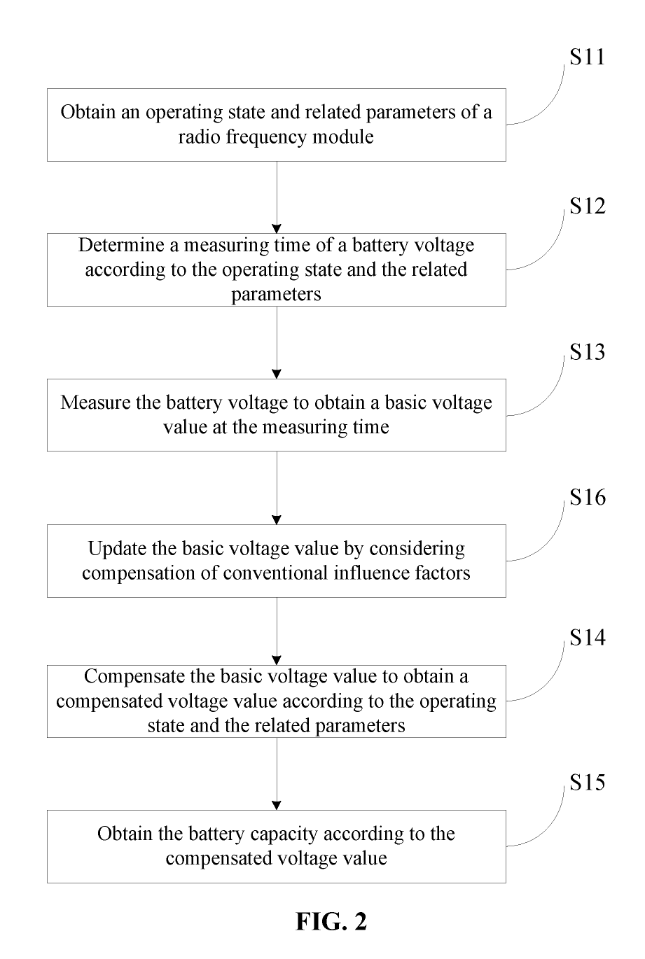

FIG. 2 shows a preferred embodiment of the method for measuring the quantity of electric charge of battery of the mobile communication terminal equipment according to the embodiments of this application, and in comparison with the method for measuring the quantity of electric charge of battery of the mobile communication terminal equipment in FIG. 1, a step S16: updating the basic voltage value according to conventional influence factors, is added between steps S13 and S14 of the method.

In this step, any method for measuring the quantity of electric charge of battery of common terminal equipment in the prior art may be adopted to compensate for the influences of the factors, such as an environment temperature, battery aging, backlight intensity and processor frequency, on the battery voltage. The mobile communication terminal equipment also includes power consuming equipment, such as a display backlight, a central processing unit (CPU) and a graphics processing unit (GPU) in the common terminal equipment. The power consuming equipment and the factors including the environment temperature, battery aging and the like will also cause fluctuation to the battery voltage of the mobile communication terminal equipment. Therefore, the influences of these factors on the battery voltage are compensated in the present embodiment, and the quantity of electric charge of battery of the mobile communication terminal equipment can be measured more accurately.

Hereinafter, the steps of determining the measuring time of the battery voltage and compensating the basic voltage value are further described in detail by taking a radio frequency transceiver as an example of the radio frequency.

The step of determining the measuring time of the battery voltage may be divided into the four situations as follows:

1) when the operating state S_{TX} of the transmitting unit of the radio frequency transceiver, received by the microprocessor, represents that the transmitting unit of the radio frequency transceiver is ready to transmit a signal, the microprocessor calculates the measuring time t_{VM} of the battery voltage for each transmitting time slot respectively, where t_{TX}<t_{VM}<t_{TX}+D_{TX}, namely the measuring time t_{VM} falls within the operating time period of the radio frequency module, and preferably, t_{VM}=t_{TX}+D_{TX}/2, namely the measuring time t_{VM} is the midpoint of the operating time period of the transmitting module of the radio frequency module.

2) when the operating state S_{RX} of the receiving unit of the radio frequency transceiver, received by the microprocessor, represents that the receiving unit of the radio frequency transceiver is ready to receive a signal, the microprocessor calculates the measuring time t_{VM} of the battery voltage for each transmitting time slot respectively, where t_{RX}<t_{VM}<t_{RX}+D_{RX}, namely the measuring time t_{VM} falls within the operating time period of the radio frequency module, and preferably, t_{VM}=t_{RX}+D_{RX}/2, namely the measuring time t_{VM} is the midpoint of the operating time period of the receiving module of the radio frequency module.

3) when the operating states S_{TX} and S_{RX} of the radio frequency transceiver, received by the microprocessor, represent that the transmitting unit of the radio frequency transceiver is ready to transmit a signal and the receiving unit of the radio frequency transceiver is ready toreceive a signal, the microprocessor calculates a first measuring time t_{VM1} of the battery voltage for each transmitting time slot respectively, calculates a second measuring time t_{VM2} of the battery voltage for each transmitting time slot respectively, determines the sequence of the first measuring time t_{VM1} and the second measuring time t_{VM2}, and takes the earlier one of them as the measuring time of the battery voltage.

4) when the operating states S_{TX} and S_{RX} of the radio frequency transceiver, received by the microprocessor, represent that the radio frequency transceiver does not have actions of transmitting and receiving signals, at that moment, the radio frequency transceiver is in an idle state, consumes very low power, and has negligible influence on the fluctuation of the battery voltage. In this case, the method for measuring the quantity of electric charge of battery is the same as that of common terminal equipment in the prior art.

Correspondingly, the step of compensating the basic voltage value may also be divided into the four situations as follows:

1) when the basic voltage value V₀ is obtained when the transmitting unit of the radio frequency transceiver is in operation, V_{C}=V₀+ΔV_{TX}(P_{TX}), where ΔV_{TX}(P_{TX}) represents a compensation voltage related to a transmitting power P_{TX}, and preferably a relation table showing the correspondence between ΔV_{TX} and P_{TX} can be pre-stored in a memory of the mobile communication terminal equipment, so that the compensation voltage can be obtained very easily in use with reference to the table.

2) when the basic voltage value V₀ is obtained when the receiving unit of the radio frequency transceiver is in operation, V_{C}=V₀+ΔV_{RX}(G_{RX}), where ΔV_{RX}(G_{RX}) represents a compensation voltage related to a receive gain G_{RX}, and in the same way, preferably a relation table showing the correspondence between ΔV_{RX} and G_{RX} can be pre-stored in a memory of the mobile communication terminal equipment, so that the compensation voltage can be obtained very easily in use with reference to the table.

3) when the basic voltage value V₀ is obtained when the transmitting unit and the receiving unit of the radio frequency transceiver are in operation, V_{C}=V₀+ΔV_{TX}(P_{TX})+ΔV_{RX}(G_{RX}), where ΔV_{TX}(P_{TX}) represents a compensation voltage related to a transmitting power P_{TX}, ΔV_{RX}(G_{RX}) represents a compensation voltage related to a receive gain G_{RX}, and in the same way, preferably a relation table showing the correspondence between ΔV_{TX} P_{TX} and a relation table showing the correspondence between ΔV_{RX} and G_{RX} can be pre-stored in a memory of the mobile communication terminal equipment, so that the compensation voltage can be obtained very easily in use with reference to the tables.

4) when the basic voltage value V₀ is obtained when neither the transmitting unit and the receiving unit of the radio frequency transceiver is in operation, at that moment, the radio frequency transceiver is in an idle state, consumes very low power, and has negligible influence on the fluctuation of the battery voltage. In this case, the basic voltage value V₀ does not need compensation for the factor of the radio frequency transceiver, namely V_{C}=V₀.

### Embodiment 2

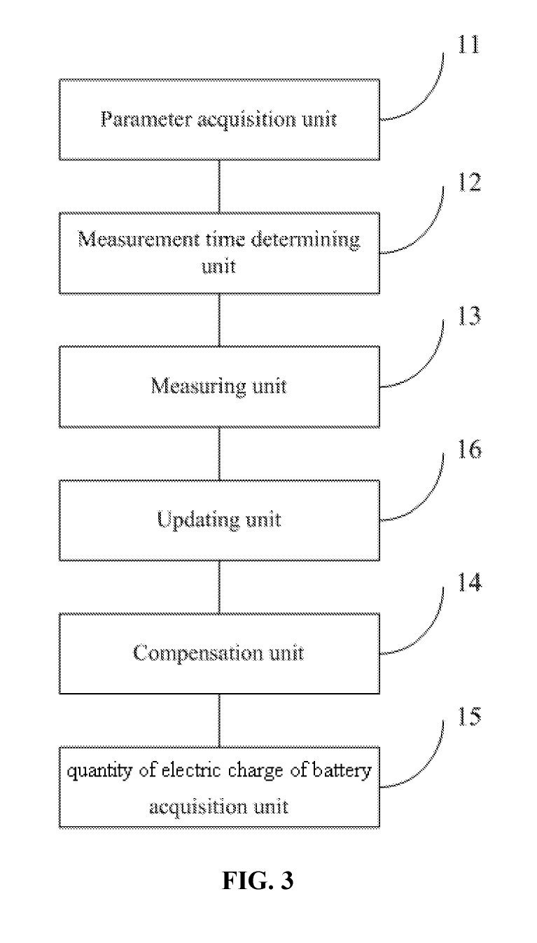

As shown in FIG. 3, the embodiment of this application also provides a system for measuring quantity of electric charge of battery of mobile communication terminal equipment. The system includes:

a parameter acquisition unit 11, for acquiring an operating state and related parameters of a radio frequency module;

a measuring time determining unit 12, for determining a measuring time t_{VM} of a battery voltage according to the operating state and the related parameters of the radio frequency module;

a measuring unit 13, for measuring the battery voltage to obtain a basic voltage value V₀ at the measuring time t_{VM};

a compensating unit 14, for compensating the basic voltage value V₀ to obtain a compensated voltage value V_{C} according to the operating state and the related parameters of the radio frequency module; and

a quantity of electric charge of battery acquisition unit 15, for obtaining the quantity of electric charge of battery according to the compensated voltage value V_{C}.

The further detailed description of each of the units is the same as that of the previous embodiment, and is not mentioned herein. According to the system for measuring the quantity of electric charge of battery of the mobile communication terminal equipment, provided by the embodiment of this application, a measuring time of the battery voltage is determined according to the operating state and the related parameters of the radio frequency module, a basic voltage value is obtained by measuring at the measuring time, and a compensated voltage value is obtained according to the operating state and the related parameters of the radio frequency module to compensate the influence of the radio frequency module on the fluctuation of the battery voltage, so that the quantity of electric charge of battery of the mobile communication terminal equipment can be accurately obtained.

As a preferred implementation mode, the system for measuring the quantity of electric charge of battery of the mobile communication terminal equipment according to the embodiment of this application also includes an updating unit 16 for updating the basic voltage value according to conventional influence factors, after measuring the battery voltage by the measuring unit 13 to obtain a basic voltage value and before compensating the basic voltage value by the compensating unit 14 to obtain a compensated voltage value.

With the updating unit 16, it is able to compensate the fluctuation of the quantity of electric charge of battery caused by the power consuming equipment such the display backlight, a central processing unit (CPU) and a graphics processing unit (GPU) as those in the common terminal equipment, and the factors including the environment temperature, battery aging and the like, so as to more accurately measure the quantity of electric charge of battery of the mobile communication terminal equipment.

Hereinafter, the system for measuring the quantity of electric charge of battery of the mobile communication terminal equipment according to the embodiment of this application is further described in detail by taking a radio frequency transceiver as an example of the radio frequency module.

As a preferred embodiment, the measuring time determining unit 12 may include:

a first determining unit, for, when the operating state indicates that a transmitting unit of the radio frequency transceiver is ready to transmit a signal, calculating the measuring time t_{VM} (t_{TX}<t_{VM}<t_{TX}+D_{TX}) of the battery voltage for each transmitting time slot respectively, where t_{TX} represents the transmitting start time of each transmitting time slot, and D_{TX} represents a transmitting duration;

a second determining unit, for, when the operating state indicates that a receiving unit of the radio frequency transceiver is ready to receive a signal, calculating the measuring time t_{VM} (t_{RX}<t_{VM}<t_{TX}+D_{RX}) of the battery voltage for each transmitting time slot, where t_{RX} represents the receiving start time of each receiving time slot, and D_{RX} represents a receiving duration; and

a third determining unit, for, when the operating state indicates that the transmitting unit of the radio frequency transceiver is ready to transmit a signal, and the receiving unit of the radio frequency transceiver is ready to receive a signal, calculating a first measuring time t_{VM1} (t_{TX}<t_{VM1}<t_{TX}+D_{TX}) of the battery voltage for each transmitting time slot, calculating a second measuring time t_{VM2} (t_{RX}<t_{VM2}<t_{TX}+D_{RX}) of the battery voltage for each transmitting time slot, determining the sequence of the first measuring time t_{VM1} and the second measuring time t_{VM2}, and taking the earlier one of them as the measuring time of the battery voltage;

a fourth determining unit, when the working state indicates that the ratio frequency transceiver does not have actions of transmitting and receiving signals, at that moment, the ratio frequency transceiver is in an idle state, consumes very low power, and has negligible influence on the fluctuation of battery voltage. In this circumstance, the way of measuring quantity of electric charge of battery is the same as that for general terminal equipment in the prior arts.

As a preferred embodiment, the compensating unit 14 may include:

a first compensating subunit, for, when the basic voltage value V₀ is obtained when the transmitting unit of the radio frequency transceiver is in operation, determining the compensated voltage value V_{C}=V₀+ΔV_{TX}(P_{TX}), where ΔV_{TX}(P_{TX}) represents the compensated voltage related to the transmitting power P_{TX} of the radio frequency transceiver;

a second compensating subunit, for, when the basic voltage value V₀ is obtained when the receiving unit of the radio frequency transceiver is in operation, determining the compensated voltage value V_{C}=V₀+ΔV_{RX}(G_{RX}), where ΔV_{RX}(G_{RX}) represents the compensated voltage related to the receive gain G_{RX} of the radio frequency transceiver;

a third compensating subunit, for, when the basic voltage value V₀ is obtained when both of the transmitting unit and the receiving unit of the radio frequency transceiver are in operation, determining the compensated voltage value V_{C}=V₀+ΔV_{TX}(P_{TX})+ΔV_{RX}(G_{RX}); where, ΔV_{TX}(P_{TX}) represents a compensation voltage related to a transmitting power P_{TX} of the radio frequency transceiver, and ΔV_{RX}(G_{RX}) represents a compensation voltage related to a receive gain G_{RX} of the radio frequency transceiver; and

a fourth compensating subunit, when the basic voltage value V₀ is obtained when neither of the transmitting unit and the receiving unit of the radio frequency transceiver is in operation and the ratio frequency transceiver is in idle state, consumes very low power, and has negligible influence on the fluctuation of battery voltage. In this circumstance, there is no need of compensation for the basic voltage value V₀ due to the factor of the radio frequency transceiver, i.e. Vc=V₀.

### Embodiment 3

The embodiment of this application provides a non-volatile computer storage medium storing computer executable instructions that can execute the method for measuring the quantity of electric charge of battery of the mobile communication terminal equipment according to the embodiments of any of the abovementioned methods.

### Embodiment 4

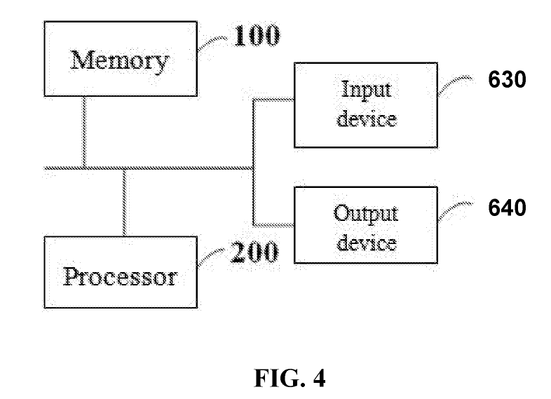

FIG. 4 shows a schematic diagram of a hardware structure of the electronic device for executing the method for measuring the quantity of electric charge of battery of the mobile communication terminal equipment provided by an embodiment of this application, and as shown in FIG. 4, the device includes one or more processors 200 and a memory 100, and one processor 200 is taken as an example in FIG. 4. The electronic device for executing the method for measuring the quantity of electric charge of battery of the mobile communication terminal equipment may further include: an input device 630 and an output device 640.

The processor 200, the memory 100, the input device 630 and the output device 640 may be connected with a bus or in other ways, and bus connection is taken as an example in FIG. 4.

The memory 100, as a non-volatile computer readable storage medium, may be used for storing non-volatile software programs, non-volatile computer executable programs and modules, for example, program instructions/modules (e.g., a parameter acquisition unit 11, a measuring time determining unit 12, a measuring unit 13, an updating unit 16, a compensating unit 14 and a quantity of electric charge of battery acquisition unit 15 shown in FIG. 3) corresponding to the method for measuring the quantity of electric charge of battery of the mobile communication terminal equipment in the embodiments of this application. The processor 200 runs the non-volatile software programs, instructions and modules stored in the memory 100 so as to execute various functional applications and data processing of a server, thereby implementing the method for measuring the quantity of electric charge of battery of the mobile communication terminal equipment in the abovementioned embodiments of the methods.

The memory 100 may include a program storage area and a data storage area, where the program storage area may store an operating system and applications for at least one functions; and the data storage area may store data and the like created according to the use of the system for measuring the quantity of electric charge of battery of the mobile communication terminal equipment. Moreover, the memory 100 may include a high-speed random access memory, and may also include a non-volatile memory, for example, at least one disk storage device, a flash memory, or other non-volatile solid storage devices. In some embodiments, the memory 100 optionally includes memories that are set remotely relative to the processor 200, and these remote memories may be connected to the system for measuring the quantity of electric charge of battery of the mobile communication terminal equipment through a network. An example of the network includes, but is not limited to, internet, intranet, LAN, mobile communication network, and the combinations thereof.

The input device 630 may receive input digit or character information, and generate a key signal input related to the user configuration and function control of the system for measuring the quantity of electric charge of battery of the mobile communication terminal equipment. The output device 640 may include display devices, such as a display screen.

The one or more modules are stored in the memory 100, and when executed by the one or more processors 200, perform the method for measuring the quantity of electric charge of battery of the mobile communication terminal equipment according to the embodiments of any one of the abovementioned methods.

The abovementioned product can perform the method provided by the embodiments of this application and has corresponding functional modules for executing the method and beneficial effects. For more technical details of this embodiment, please refer to the method provided by the embodiments of this application.

The electronic device of the embodiments of this application can exist in many forms, including but not limited to:

(1) Mobile communication devices: the characteristics of such devices are that they have mobile communication functions, and mainly aim to provide voice and data communication. Such terminals include: smart phones (such as iPhone), multimedia phones, feature phones, low-end phones, etc.

(2) Ultra-mobile personal computer devices: such devices belong to the category of personal computers, have computing and processing functions and usually also have mobile internet access features. Such terminals include: PDA, MID, UMPC devices, etc., such as iPad.

(3) Portable entertainment devices: such devices are able to display and play multimedia contents. Such devices include: audio and video players (such as iPod), handheld game players, electronic books, smart toys, and portable vehicle navigation devices.

(4) Servers: devices providing computing services. The structure of a server includes a processor, hard disks, an internal memory, an electronic device bus, etc. Structures of the servers are similar to that of a general purpose computer, but because of the need of providing highly reliable services, the server has higher requirements in aspects of processing capability, stability, reliability, security, expandability, manageability, etc.

(5) Other electronic devices having data interaction function.

The embodiments of the abovementioned devices are only illustrative, where the units described as separate parts may be or may not be physically separated, and the components shown as a unit may be or may not be physical unit, i.e. may be located in one place, or may be distributed to multiple network units. According to actual needs, part or all of the modules therein may be selected to realize the objectives of the solution of the embodiment.

By the description of the above embodiments, those skilled in the art can clearly understand that various embodiments may be implemented by means of software and a general hardware platform, and of course, may also be implemented by means of hardware. Based on such understanding, the abovementioned technical solution may be essentially reflected, or the parts thereof making contribution to related technology may be reflected in the form of software products. Such computer software products may be stored in a computer readable storage medium such as an ROM/RAM, a magnetic disk or an optical disk, etc., and may include a number of instructions to enable a computer device (which may be a personal computer, a server, or a network device, etc.) to execute the methods described in various embodiments or in some parts thereof.

Finally, it should be noted that: the abovementioned embodiments are merely illustrated for describing rather than limiting the technical solutions of this application; although detailed description of this application is given with reference to the abovementioned embodiments, those skilled in the art should understand that they still can modify the technical solutions recorded in the abovementioned various embodiments or replace part of the technical features therein with equivalents; and these modifications or replacements would not cause the essence of the corresponding technical solutions to depart from the spirit and scope of the technical solutions according to various embodiments of this application.

What is claimed is:

1. A method for measuring quantity of electric charge of battery of mobile communication terminal equipment, comprising:
acquiring an operating state and related parameters of a radio frequency module;
determining a measuring time of a battery voltage according to the operating state and the related parameters;
measuring the battery voltage to obtain a basic voltage value at the measuring time;
compensating the basic voltage value to obtain a compensated voltage value according to the operating state and the related parameters; and
obtaining the quantity of electric charge of battery according to the compensated voltage value.

2. The method according to claim 1, wherein the radio frequency module is a radio frequency transceiver.

3. The method according to claim 2, wherein the step of determining the measuring time of the battery voltage according to the operating state and the related parameters comprises:
when the operating state indicates that a transmitting unit of the radio frequency transceiver is ready to transmit a signal, calculating the measuring time t_{VM} (t_{TX}<t_{VM}<t_{TX}+D_{TX}) of the battery voltage for each transmitting time slot respectively, wherein t_{TX} represents the transmitting start time of each transmitting time slot, and D_{TX} represents a transmitting duration;
when the operating state indicates that a receiving unit of the radio frequency transceiver is ready to receive a signal, calculating the measuring time t_{VM} (t_{RX}<t_{VM}<t_{TX}+D_{RX}) of the battery voltage for each transmitting time slot, wherein t_{RX} represents the receiving start time of each receiving time slot, and D_{RX} represents a receiving duration; and
when the operating state indicates that the transmitting unit of the radio frequency transceiver is ready to transmit a signal and the receiving unit of the radio frequency transceiver is ready to receive a signal, calculating a first measuring time t_{VM1} (t_{TX}<t_{VM1}<t_{TX}+D_{TX}) of the battery voltage for each transmitting time slot, calculating a second measuring time t_{VM2} (t_{RX}<t_{VM2}<t_{TX}+D_{RX}) of the battery voltage for each transmitting time slot, determining the sequence of the first measuring time t_{VM1} and the second measuring time t_{VM2}, and taking the earlier one of them as the measuring time of the battery voltage.

4. The method according to claim 2, wherein the step of compensating the basic voltage value to obtain the compensated voltage value comprises:
when the basic voltage value is obtained when the transmitting unit of the radio frequency transceiver is in operation, determining the compensated voltage value V_{C}=V₀+ΔV_{TX}(P_{TX});
when the basic voltage value is obtained when the receiving unit of the radio frequency transceiver is in operation, determining the compensated voltage value V_{C}=V₀+ΔV_{RX}(G_{RX}); and
when the basic voltage value is obtained when both of the transmitting unit and the receiving unit of the radio frequency transceiver are in operation, determining the compensated voltage value V_{C}=V₀+ΔV_{TX}(P_{TX})+ΔV_{RX}(G_{RX});
wherein V₀ represents the basic voltage value, ΔV_{TX}(P_{TX}) represents a compensation voltage related to a transmitting power P_{TX} of the radio frequency transceiver, and ΔV_{RX}(G_{RX}) represents a compensation voltage related to a receive gain G_{RX} of the radio frequency transceiver.

5. The method according to claim 3, wherein the step of compensating the basic voltage value to obtain the compensated voltage value comprises:
when the basic voltage value is obtained when the transmitting unit of the radio frequency transceiver is in operation, determining the compensated voltage value V_{C}=V₀+ΔV_{TX}(P_{TX});
when the basic voltage value is obtained when the receiving unit of the radio frequency transceiver is in operation, determining the compensated voltage value V_{C}=V₀+ΔV_{RX}(G_{RX}); and
when the basic voltage value is obtained when both of the transmitting unit and the receiving unit of the radio frequency transceiver are in operation, determining the compensated voltage value V_{C}=V₀+ΔV_{TX}(P_{TX})+ΔV_{RX}(G_{RX});
wherein V₀ represents the basic voltage value, ΔV_{TX}(P_{TX}) represents a compensation voltage related to a transmitting power P_{TX} of the radio frequency transceiver, and ΔV_{RX}(G_{RX}) represents a compensation voltage related to a receive gain G_{RX} of the radio frequency transceiver.

6. The method according to claim 1, further comprising, between the step of measuring the battery voltage to obtain a basic voltage value and the step of compensating the basic voltage value to obtain a compensated voltage value:
updating the basic voltage value according to conventional influence factors.

7. An electronic device, comprising:
at least one processor; and
a memory in communication connection with the at least one processor; wherein,
the memory stores instructions that, when executed by the at least one processor, enable the at least one processor to:
acquire an operating state and related parameters of a radio frequency module;
determine a measuring time of a battery voltage according to the operating state and the related parameters;
measure the battery voltage to obtain a basic voltage value at the measuring time;
compensate the basic voltage value to obtain a compensated voltage value according to the operating state and the related parameters; and
obtain the quantity of electric charge of battery according to the compensated voltage value.

8. The electronic device according to claim 7, wherein the radio frequency module is a radio frequency transceiver.

9. The electronic device according to claim 8, wherein the step of determining the measuring time of the battery voltage according to the operating state and the related parameters comprises:
when the operating state indicates that a transmitting unit of the radio frequency transceiver is ready to transmit a signal, calculating the measuring time t_{VM} (t_{TX}<t_{VM}<t_{TX}+D_{TX}) of the battery voltage for each transmitting time slot respectively, wherein t_{TX} represents the transmitting start time of each transmitting time slot, and D_{TX} represents a transmitting duration;
when the operating state indicates that a receiving unit of the radio frequency transceiver is ready to receive a signal, calculating the measuring time t_{VM} (t_{RX}<t_{VM}<t_{TX}+D_{RX}) of the battery voltage for each transmitting time slot, wherein t_{RX} represents the receiving start time of each receiving time slot, and D_{RX} represents a receiving duration; and
when the operating state indicates that the transmitting unit of the radio frequency transceiver is ready to transmit a signal, and the receiving unit of the radio frequency transceiver is ready to receive a signal, calculating a first measuring time t_{VM1} (t_{TX}<t_{VM1}<t_{TX}+D_{TX}) of the battery voltage for each transmitting time slot, calculating a second measuring time t_{VM2} (t_{RX}<t_{VM2}<t_{TX}+D_{RX}) of the battery voltage for each transmitting time slot, determining the sequence of the first measuring time t_{VM1} and the second measuring time t_{VM2}, and taking the earlier one of them as the measuring time of the battery voltage.

10. The electronic device according to claim 8, wherein the step of compensating the basic voltage value to obtain the compensated voltage value comprises:
when the basic voltage value is obtained when the transmitting unit of the radio frequency transceiver is in operation, determining the compensated voltage value V_{C}=V₀+ΔV_{TX}(P_{TX});
when the basic voltage value is obtained when the receiving unit of the radio frequency transceiver is in operation, determining the compensated voltage value V_{C}=V₀+ΔV_{RX}(G_{RX}); and
when the basic voltage value is obtained when both of the transmitting unit and the receiving unit of the radio frequency transceiver are in operation, determining the compensated voltage value V_{C}=V₀+ΔV_{TX}(P_{TX})+ΔV_{RX}(G_{RX});
wherein V₀ represents the basic voltage value, ΔV_{TX}(P_{TX}) represents a compensation voltage related to a transmitting power P_{TX} of the radio frequency transceiver, and ΔV_{RX}(G_{RX}) represents a compensation voltage related to a receive gain G_{RX} of the radio frequency transceiver.

11. The electronic device according to claim 9, wherein the step of compensating the basic voltage value to obtain the compensated voltage value comprises:
when the basic voltage value is obtained when the transmitting unit of the radio frequency transceiver is in operation, determining the compensated voltage value V_{C}=V₀+ΔV_{TX}(P_{TX});
when the basic voltage value is obtained when the receiving unit of the radio frequency transceiver is in operation, determining the compensated voltage value V_{C}=V₀+ΔV_{RX}(G_{RX}); and
when the basic voltage value is obtained when both of the transmitting unit and the receiving unit of the radio frequency transceiver are in operation, determining the compensated voltage value V_{C}=V₀+ΔV_{TX}(P_{TX})+ΔV_{RX}(G_{RX});
wherein V₀ represents the basic voltage value, ΔV_{TX}(P_{TX}) represents a compensation voltage related to a transmitting power P_{TX} of the radio frequency transceiver, and ΔV_{RX}(G_{RX}) represents a compensation voltage related to a receive gain G_{RX} of the radio frequency transceiver.

12. The electronic device according to claim 7, wherein between the step of measuring the battery voltage to obtain a basic voltage value and the step of compensating the basic voltage value to obtain a compensated voltage value, the basic voltage value is updated according to conventional influence factors.

13. A non-volatile computer storage medium, storing computer executable instructions for:
acquiring an operating state and related parameters of a radio frequency module;
determining a measuring time of a battery voltage according to the operating state and the related parameters;
measuring the battery voltage to obtain a basic voltage value at the measuring time;
compensating the basic voltage value to obtain a compensated voltage value according to the operating state and the related parameters; and
obtaining the quantity of electric charge of battery according to the compensated voltage value.

14. The non-volatile computer storage medium according to claim 13, wherein the radio frequency module is a radio frequency transceiver.

15. The non-volatile computer storage medium according to claim 14, wherein the step of determining the measuring time of the battery voltage according to the operating state and the related parameters comprises:
when the operating state indicates that a transmitting unit of the radio frequency transceiver is ready to transmit a signal, calculating the measuring time t_{VM} (t_{TX}<t_{VM}<t_{TX}+D_{TX}) of the battery voltage for each transmitting time slot respectively, wherein t_{TX} represents the transmitting start time of each transmitting time slot, and D_{TX} represents a transmitting duration;
when the operating state indicates that a receiving unit of the radio frequency transceiver is ready to receive a signal, calculating the measuring time t_{VM} (t_{RX}<t_{VM}<t_{TX}+D_{TX}) of the battery voltage for each transmitting time slot, wherein t_{RX} represents the receiving start time of each receiving time slot, and D_{RX} represents a receiving duration; and
when the operating state indicates that the transmitting unit of the radio frequency transceiver is ready to transmit a signal, and the receiving unit of the radio frequency transceiver is ready to receive a signal, calculating a first measuring time t_{VM1} (t_{TX}<t_{VM1}<t_{TX}+D_{TX}) of the battery voltage for each transmitting time slot, calculating a second measuring time t_{VM2} (t_{RX}<t_{VM2}<t_{TX}+D_{RX}) of the battery voltage for each transmitting time slot, determining the sequence of the first measuring time t_{VM1} and the second measuring time t_{VM2}, and taking the earlier one of them as the measuring time of the battery voltage.

16. The non-volatile computer storage medium according to claim 14, wherein the step of compensating the basic voltage value to obtain the compensated voltage value comprises:
when the basic voltage value is obtained when the transmitting unit of the radio frequency transceiver is in operation, determining the compensated voltage value V_{C}=V₀+ΔV_{TX}(P_{TX});
when the basic voltage value is obtained when the receiving unit of the radio frequency transceiver is in operation, determining the compensated voltage value V_{C}=V₀+ΔV_{RX}(G_{RX}); and
when the basic voltage value is obtained when both of the transmitting unit and the receiving unit of the radio frequency transceiver are in operation, determining the compensated voltage value V_{C}=V₀+ΔV_{TX}(P_{TX})+ΔV_{RX}(G_{RX});
wherein V₀ represents the basic voltage value, ΔV_{TX}(P_{TX}) represents a compensation voltage related to a transmitting power P_{TX} of the radio frequency transceiver, and ΔV_{RX}(G_{RX}) represents a compensation voltage related to a receive gain G_{RX} of the radio frequency transceiver.

17. The non-volatile computer storage medium according to claim 13, wherein between the step of measuring the battery voltage to obtain a basic voltage value and the step of compensating the basic voltage value to obtain a compensated voltage value, the computer executable instructions are also used for updating the basic voltage value according to conventional influence factors.
